(19) United States
(12) Patent Application Publication
(10) Pub. No.: US 2025/0308471 A1
(43) Pub. Date: Oct. 2, 2025

(54) SOURCE BASED LOCAL DIMMING

(71) Applicant: ATI Technologies ULC, Markham (CA)

(72) Inventors: Anthony WL Koo, Markham (CA); Shu Key Keith Lee, Markham (CA); Troy Alexander Giorshecv, Markham (CA)

(73) Assignee: ATI Technologies ULC, Markham (CA)

(21) Appl. No.: 18/620,732

(22) Filed: Mar. 28, 2024

(51) Int. Cl. G09G 3/34

(52) U.S. Cl. CPC G09G 3/3426; G09G 2320/0646; G09G 2354/00; G09G 2360/16

(57) ABSTRACT

Devices, methods, and systems for local dimming of a display backlight. Information is received from a host device. A luminance of at least one region of the display backlight is adjusted, based on the information received from the host device. In some implementations, the information received from the host device indicates at least one of: local dimming control information; global backlight luminance information; and/or backlight zone output luminance information. In some implementations, display device information is transmitted to the host device. In some implementations, the display device information indicates at least one of: backlight zone control support, maximum average backlight luminance, peak zone luminance, peak center zone luminance, peak edge zone luminance, a panel light spread function, backlight zone columns, backlight zone rows, backlight zone arrangement, backlight arrangement within a zone, information mapping backlight drive strength to backlight luminance, and/or backlight luminance granularity.

### BACKGROUND

In modern liquid crystal displays (LCD) and other displays, a backlight illuminates a color filter array, which colors the light that is emitted from the backlight in order to present an image to the user. The backlight consumes energy and may generate heat. In some cases, such displays cannot achieve a true black color for pixels that are illuminated by the backlight.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is an exploded view of an example display;

FIG. 3 is a block diagram illustrating an example backlight and color filter array;

FIG. 4 is a block diagram illustrating an example display in communication with an example host device;

FIG. 5A is a block diagram illustrating an example backlight zone and surrounding zones to which it contributes luminance;

FIG. 5B is a block diagram illustrating another example backlight zone and surrounding zones to which it contributes luminance;

FIG. 6A is a block diagram which illustrates an example backlight zone arrangement;

FIG. 6B is a block diagram which illustrates another example backlight zone arrangement;

FIG. 6C is a block diagram which illustrates another example backlight zone arrangement;

FIG. 7 is a block diagram illustrating an example backlight of a display; and

FIG. 8 is a flow chart illustrating an example procedure for host- or source-controlled local backlight dimming.

### DETAILED DESCRIPTION

Electronic visual displays are commonly used to provide data output from computing or communications devices in a form that is easily discernable to users. Such displays are often referred to as monitors. Contemporary displays are typically flat LCD panels configured to receive a signal from a computing device for display as video, although different display technologies have been used and these technologies continue to evolve.

In some implementations, displays receive data for display from an output interface of a communications source device. In some cases the display data is formatted according to a particular video standard. Different video standards have been and continue to be in use, including composite video, video graphics array (“VGA”), Digital Video Interface (“DVI”), Serial Digital Interface (“SDI”), High-Definition Multimedia Interface “HDMI”, and DisplayPort™ (as promulgated by the Video Electronics Standard Association, “VESA”), among others.

The DisplayPort™ standard (“DP”), for example, relies on packetized data transmission from the source to the sink (e.g., monitor or other display, such as an embedded laptop display. As used herein, DisplayPort and DP refer to the DisplayPort v2.1 standard issued by the Video Electronics Standards Association (VESA), which is incorporated by reference in its entirety as if fully set forth herein, and other DP and other protocol standards and versions forward or backward compatible therewith, such as eDB v1.5.

Some implementations provide a method for local dimming of a display backlight implemented in a display device. Information is received from a host device. A luminance of at least one region of the display backlight is adjusted, based on the information received from the host device.

In some implementations, the information received from the host device indicates at least one of: local dimming control information; global backlight luminance information; and/or backlight zone output luminance information. In some implementations, display device information is transmitted to the host device. In some implementations, the display device information indicates at least one of: backlight zone control support, maximum average backlight luminance, peak zone luminance, peak center zone luminance, peak edge zone luminance, a panel light spread function, backlight zone columns, backlight zone rows, backlight zone arrangement, backlight arrangement within a zone, information mapping backlight drive strength to backlight luminance, and/or backlight nits granularity. In some implementations, the information received from the host device is based on the transmitted display device information. In some implementations, the information received from the host device is received from the host device via at least one of AUX via Display Port Configuration Data (DPCD), chained Secondary Data Packet (SDP info) packet, data embedded in a pixel stream, and/or an embedded DisplayPort (eDP) interface. In some implementations, the information received from the host device is received synchronously with video frames. In some implementations, the information received from the host device is converted into a backlight drive strength value to control backlight luminance. In some implementations, the information received from the host device indicates a backlight drive strength to control backlight luminance. In some implementations, the display device information includes a table mapping backlight drive strength to backlight luminance in nits or candela.

Some implementations provide a device configured for local dimming of a display backlight. The device includes receiver circuitry configured to receive information from a host device. The device also includes processor circuitry configured to adjust a luminance of at least one region of the display backlight, based on the information received from the host device.

In some implementations, the information received from the host device indicates at least one of: local dimming control information; global backlight luminance information; and/or backlight zone output luminance information. In some implementations, the device includes transmitter circuitry configured to transmit display device information to the host device. In some implementations, the display device information indicates at least one of: backlight zone control support, maximum average backlight luminance, peak zone luminance, peak center zone luminance, peak edge zone luminance, a panel light spread function, backlight zone columns, backlight zone rows, backlight zone arrangement, backlight arrangement within a zone, information mapping backlight drive strength to backlight luminance, and/or backlight nits granularity. In some implementations, the information received from the host device is based on the transmitted display device information. In some implementations, the information received from the host device is received from the host device via at least one of AUX via DPCD, chained SDP info packet, data embedded in a pixel stream, and/or an eDP interface. In some implementations, the information received from the host device is received synchronously with video frames. In some implementations, the processor circuitry is further configured to convert the information received from the host device into a backlight drive strength value to control backlight luminance. In some implementations, the information received from the host device indicates a backlight drive strength to control backlight luminance. In some implementations, the display device information includes a table mapping backlight drive strength to backlight luminance.

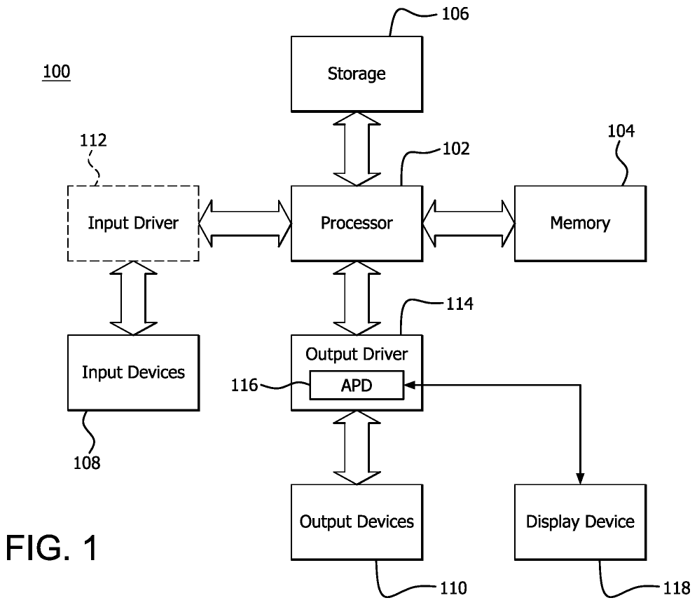

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. In some implementations, APD 116 is or includes a DP source device, and display device 118 is or includes a DP sink device. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm can also perform the functionality described herein.

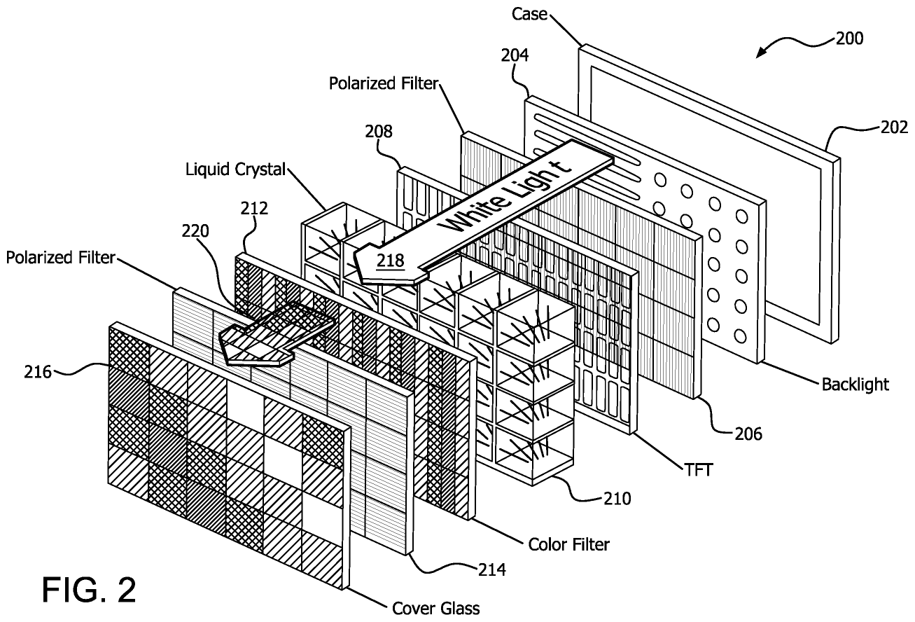

FIG. 2 is an exploded view of an example display 200. Display 200 is an LCD display in this example. Display 200 includes a case 202, backlight 204, polarized filter array 206, thin film transistor (TFT) array 208, liquid crystal array 210, color filter array 212, polarized filter array 214, and cover glass 216.

In some implementations, polarized Filter 206 is or includes an optical filter, e.g., which polarizes the light emitted by the backlight. In some implementations, TFT Array 208 is or includes an array of transistors with one for each sub-pixel in the display. These control an electric field which, together with the Liquid Crystal Material, control the polarization of the light. In some implementations, liquid crystal array 210 is or includes a layer of liquid crystal material. Together with the electric field applied by the TFT Array, this controls the polarization of the light. In some implementations, color filter array 212 is or includes an array of color filters, e.g., with one for each sub-pixel of the display. In some implementations, these absorb some wavelengths of light while allowing others to pass, resulting in colored light. In some implementations, polarized filter 214 is or includes an optical filter which partially blocks the colored light, e.g., depending on its polarization.

In display 200, white light 218 (or other suitable light) from backlight 204 shines through polarized filter array 206, thin film transistor (TFT) array 208, liquid crystal array 210, and color filter array 212 as shown and is modulated by liquid crystal array 210 and filtered by color filter array 212 to generate colored light 220, which is displayed to a user through cover glass 216.

One approach to controlling energy consumption and/or color of pixels that are illuminated by a display backlight, such as backlight 204, is global backlight control. In a global backlight control approach, the, luminance and/or power output of the backlight is controlled for the entire backlight at once, e.g., using a single brightness value or other control information. Luminance refers to wavelength-weighted power emitted by a light source, per unit area, per unit solid angle in a particular direction. Luminance is a photometric measure of the luminous intensity per unit area of light travelling in a given direction.

Another approach to controlling energy consumption and/or color of pixels that are illuminated by a display backlight is regional backlight control. Regional backlight control is also referred to as local backlight control, or zone backlight control in some cases, and these terms are used interchangeably herein. Similarly, the terms region and zone are used interchangeably herein. In a regional backlight control approach, the luminance and/or power output of the backlight is controlled separately for individual regions or zones of the backlight, e.g., using individual brightness values or other control information.

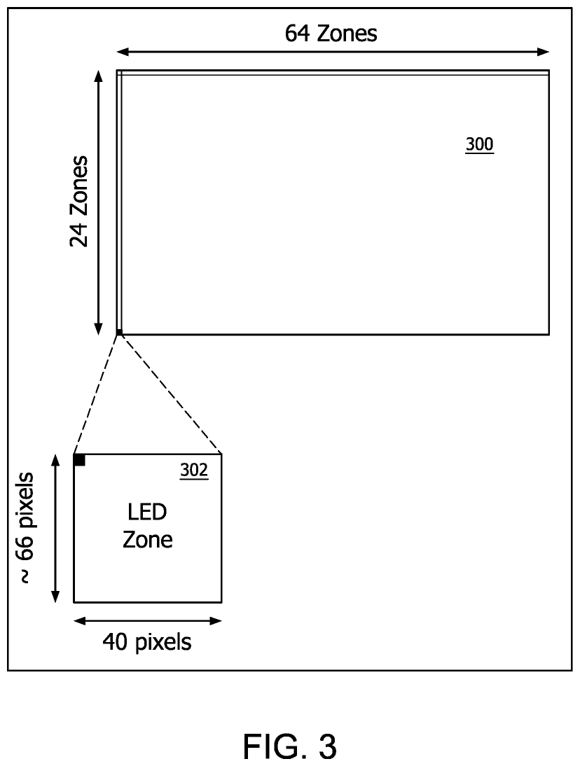

FIG. 3 is a block diagram illustrating an example backlight 300 and one example zone of a color filter array 302. Backlight 300 includes 1,536 backlight zones (24×64 zones, as shown in FIG. 3). Each zone illuminates a corresponding zone of color filter array zone 302. Each zone of the color filter array includes 2,640 pixels (66×40 pixels, as shown in FIG. 3) in this example.

One possible approach to regional backlight control leverages hardware aspects of the display or sink device to implement a regional backlight control algorithm for control of individual regions or zones of the backlight. For example, in some implementations, a timing controller (TCON) or other device of or in communication with the display device implements a regional backlight control algorithm and controls individual regions or zones of the backlight. However, in some implementations, the TCON or other device lacks system level information that would be available to the host device (e.g., DP source) which could be used to enhance regional backlight control. For example, in some implementations, the display or sink device does not have access to information regarding content type associated with the image data shown on the display, which might otherwise be used to enhance regional backlight control. Further, in some cases, the regional backlight control algorithm is not implementable on the host or source in such implementations, and in some implementations, display or sink based solutions are not uniform across all display devices.

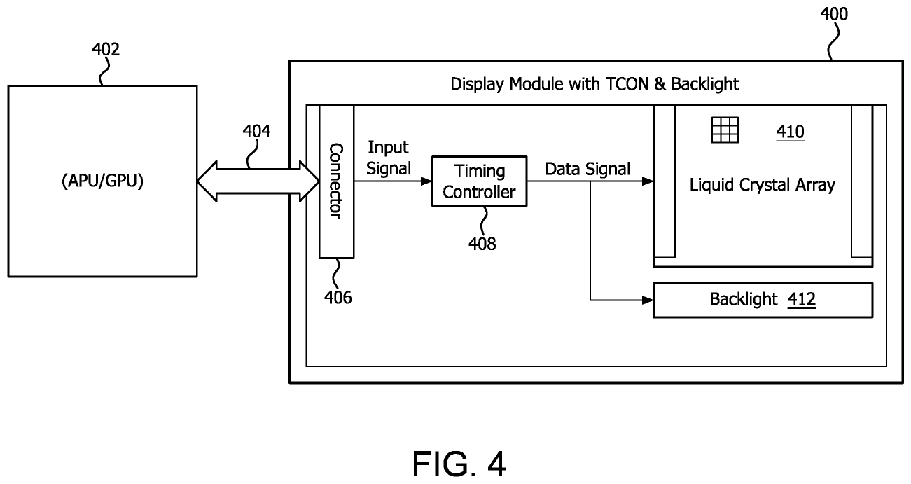

FIG. 4 is a block diagram illustrating an example display 400 in communication with an example host device 402 (APD, CPU, and/or GPU in this example) via a communications line 404. Communications line 404 is a DP line in this example (other communications standards and/or media are usable in other examples), and connects to a DP sink connector 406 of display 400 in this example (other connector and/or interfaces are usable in other examples). Communications line 400 carries an image data signal from host device 402 via the DP sink connector 406 to a timing controller (TCON) 408 (other devices are usable in other examples). Among other things, TCON 408 controls a liquid crystal array 410 of display 400, and a backlight 412 of display 400, including local dimming of backlight 412. For example, in some implementations, TCON 408 controls the backlight luminance of zones of LED drivers of backlight 412.

Another possible approach to regional backlight control leverages aspects of the VESA eDP 1.5 standard for regional backlight support. In some such approaches, the host or source device writes control information (e.g., 16 bytes of control information) to regional backlight control Display Port Configuration Data (DPCD) registers of the display or sink device over the DP Auxiliary (AUX) channel. However, in some implementations, the limited number regional backlight control DPCD registers defined by eDP 1.5 do not provide for control of a sufficient number of backlight regions or zones (e.g., provide for a maximum of 256 regions or zones). Further, DPCD communication over the DP AUX channel is asynchronous with frame updates to the display device, and relatively slow, with updates taking up to 17 DPCD transactions or hundreds of microseconds to complete, preventing timely or frame-synchronous updating of the regional backlight control DPCD registers and control of the backlight regions. Still further, in some implementations, the limited amount of data storable in the DPCD registers does not allow brightness or luminance of each region or zone of the backlight with sufficient precision (e.g., does not allow for milli-nits resolution of brightness control by a local dimming algorithm.) Yet further, in some implementations, the DPCD registers do not facilitate definition of the influence of neighboring backlight regions or zones on a particular backlight region or zone, or other advantageous control information as further discussed herein.

Accordingly, in some implementations, it may be desired to implement host or source device control of regional backlighting of the display.

In some implementations, the host or source device obtains information regarding the display or sink device in order to facilitate regional backlight control by the host or source. Any suitable information, such as information regarding display or sink device capabilities, is retrieved from the display or sink device in some implementations. This information is retrieved in any suitable manner, and is stored on the host or source device, or other device in communication with the host or source device, in any suitable manner.

For example, in some implementations, the information is retrieved by the host or source device by any one or more of (but not limited to): Extended Display Identification Data (EDID), DisplayID, and/or DPCD AUX. In some implementations, the information is stored on the host or source device, or other device in communication with the host or source device, e.g., in a basic input output system read-only memory (BIOS ROM) or in any other suitable memory or storage location (e.g., readable by driver software).

In some implementations, information regarding the display or sink device is retrievable by the host or source device, e.g., to obtain information regarding the display or sink device in order to facilitate regional backlight control by the host or source. In some implementations, the information indicates capabilities information, which indicates one or more capabilities of the display or sink device. In some implementations, the information regarding the display or sink device indicates any one or more of: backlight zone control support, backlight zone capabilities, maximum average backlight luminance, peak zone luminance, peak center zone luminance, peak edge zone luminance, peak corner zone luminance, a panel light spread function, backlight zone columns, backlight zone rows, backlight zone arrangement, backlight arrangement within a zone, and/or backlight luminance adjustment granularity.

A backlight zone control support indication, in some implementations, indicates whether the display or sink device supports host- or source-controlled regional backlight control. In some implementations, this is indicated by a bit or flag, e.g., in DPCD, DP AUX, or a field or metadata of a packet, such as an info packet, an info frame, or embedded in video data.

In examples herein, such as the description of indications, references to specific values (e.g., bit values indicating enablement or disablement, or luminance values) or to specific registers (e.g., DPCD registers) are exemplary only. Any suitable indications, bit values, or register addresses are usable in other implementations.

A description of an example backlight support indication, implemented in this example as information stored in one or more DPCD registers (without excluding other possible implementations or values), appears in Table 1:

TABLE 1

```
ADVANCED_BACKLIGHT_ZONE_CONTROL_SUPPORT
  0 = Advanced backlight zone control is not supported.
  1 = Advanced backlight zone control is supported. Sink
contains a backlight with multiple zones where each zone's
luminance can be individually controlled.
```

A description of an example backlight zone control capabilities indication, implemented in this example as information stored in one or more DPCD registers (without excluding other possible implementations or values), appears in Table 2:

```
TABLE 2
BACKLIGHT_ZONE_CONTROL_CAPABILITIES
  Defines backlight zone control capabilities when
ADVANCED_BACKLIGHT_ZONE_CONTROL_SUPPORT
= 1. When
ADVANCED_BACKLIGHT_ZONE_CONTROL_SUPPORT
= 0, the value of this register shall be “Don't Care.”
TCON_CONTROLLED_BACKLIGHT_ZONE_CAPABLE
  1 = TCON is capable of independently controlling the
backlight brightness of multiple backlight zones. Enabled when
BACKLIGHT_ZONE_CONTROL_MODE is set to enable TCON
controlled backlight zones (e.g., 01h as described in TABLE 13).
SOURCE_CONTROLLED_BACKLIGHT_ZONE_CAPABLE
  1 = Source is capable of explicitly controlling the backlight brightness of
multiple backlight zones. Enabled when BACKLIGHT_ZONE_CONTROL_MODE
is set to enable Source controlled backlight zones (e.g., 02h as described in
TABLE 13).
HYBRID_BACKLIGHT_ZONE_CAPABLE
  1 = Sink is capable of supporting a hybrid mode where both Source and
TCON are controlling the backlight brightness of multiple backlight zones. Enabled
when BACKLIGHT_ZONE_CONTROL_MODE is set to enable Hybrid controlled
backlight zones (e.g., 03h as described in TABLE 13).
CENTER_ZONE_LUMINANCE_VALID
  1 = Sink reports a unique luminance value for center zones that are different
than the ZONE_PEAK_LUMINANCE (e.g., as described in Table 4).
CORNER_ZONE_LUMINANCE_VALID
  1 = Sink reports a unique luminance value for corner zones that are different
than the ZONE_PEAK_LUMINANCE (e.g., as described in Table 4).
EDGE_ZONE_LUMINANCE_VALID
  1 = Sink reports a unique luminance value for edge zones that are different
than the ZONE_PEAK_LUMINANCE (e.g., as described in Table 4).
BACKLIGHT_ZONE_PASSTHROUGH_CONTROL_CAPABLE
  0 = Sink does not support passthrough control mode. Source must control
the backlight by transmitting a luminance (e.g., nits-based or Candela-based)
value to the Sink.
  1 = Sink supports a passthrough control mode where the Source can
directly program the backlight registers internal to the panel. Enabled when
BACKLIGHT_ZONE_PASSTHROUGH_ENABLE is set to enable Source
transmitting an internal backlight control value (e.g., a backlight drive value) that
should be directly written to the panel's internal backlight registers (e.g., 1 as
described in table 14).
```

A maximum average backlight luminance indication, in some implementations, indicates a maximum permitted luminance averaged across all individual backlight zones. In some implementations, the maximum average backlight luminance is indicated in any suitable manner, such as in units of milli-nits, or otherwise. In some implementations, the maximum average backlight luminance has the advantage of facilitating regional backlight control in displays that are limited by a peak power limit, which cannot operate at peak luminance on all LED zones simultaneously. For example, a display panel with 4 backlight zones that has a maximum average backlight luminance of 200 nits may be configured such that two backlight zones output at 400 nits while the remaining two backlight zones output at 0 nits. In another example, the same panel may be configured such that all four backlight zones output at 200 nits or less.

A description of an example maximum average backlight luminance indication, implemented in this example as information stored in one or more DPCD registers (without excluding other possible implementations or values), appears in Table 3:

TABLE 3
MAXIMUM_AVERAGE_BACKLIGHT_LUMINANCE
Stores the 24-bit maximum average luminance capable by the
panel. Source shall not set a backlight zone luminance value where
the luminance averaged across all individual backlight zones is
greater than this reported value. Value is in units of milli-nits. Valid
when ADVANCED_BACKLIGHT_ZONE_CONTROL_SUPPORT is
set to indicate that advanced backlight zone control is supported
(e.g., 1 as described with respect to Table 1.) Otherwise, the value
of this register shall be “Don't Care.”

A peak zone luminance indication, in some implementations, refers to a peak luminance value for a particular backlight zone. In some implementations each individual backlight zone may have different peak luminance due to manufacturing tolerances, due to non-uniform arrangement of LEDs, or due to other reasons. In some implementations, the separate information is provided in separate fields, (e.g., for N zones, peak zone [0] luminance . . . peak zone [N] luminance), or in an array within a single field.

A description of an example peak zone luminance indication, implemented in this example as information stored in one or more DPCD registers (without excluding other possible implementations or values), appears in Table 4:

TABLE 4
ZONE_PEAK_LUMINANCE
Stores the 24-bit peak luminance capable for each zone.
Value indicates luminance (e.g., is in units of milli-nits). Valid when
ADVANCED_BACKLIGHT_ZONE_CONTROL_SUPPORT is set to
indicate that advanced backlight zone control is supported (e.g., 1 as
described with respect to Table 1.) Otherwise, the value of this
register shall be “Don't Care.”

Optionally, in some implementations, the display or sink device may simplify and/or generalize peak zone luminance into center, edge, and corner areas. For example, a peak center zone luminance indication, in some implementations, indicates the peak luminance output when a single backlight zone that is located at the center of the backlight or panel is outputting at its maximum capacity. A peak edge zone luminance indication, in some implementations, indicates the peak luminance output when a single backlight zone that is located at an edge of the backlight or panel is outputting at its maximum capacity. A peak corner zone luminance indication, in some implementations, indicates the peak luminance output when a single backlight zone that is located at a corner of the backlight or panel is outputting at its maximum capacity.

A description of an example peak center zone luminance indication, implemented in this example as information stored in one or more DPCD registers (without excluding other possible implementations or values), appears in Table 5:

TABLE 5
CENTER_ZONE_PEAK LUMINANCE
Stores the peak luminance of center zones (e.g., in 24-bits).
Center zones are zones that have backlight zones surrounding all of
its adjacent and diagonal positions. Value indicates luminance (e.g.,
is in units of milli-nits). Valid when
ADVANCED_BACKLIGHT_ZONE_CONTROL_SUPPORT is set to
indicate that advanced backlight zone control is supported (e.g., 1 as
described with respect to Table 1. Otherwise, the value of this
register shall be “Don't Care.”

A description of an example peak corner zone luminance indication, implemented in this example as information stored in one or more DPCD registers (without excluding other possible implementations or values), appears in Table 6:

TABLE 6
CORNER_ZONE_PEAK_LUMINANCE
Stores the 24-bit peak luminance of corner zones. Corner
zones are zones that have no backlight zones surrounding two of its
adjacent sides. Value indicates luminance (e.g., is in units of milli-
nits). Valid when
ADVANCED_BACKLIGHT_ZONE_CONTROL_SUPPORT is set to
indicate that advanced backlight zone control is supported (e.g., 1 as
described with respect to Table 1. Otherwise, the value of this
register shall be “Don't Care.”

A description of an example peak edge zone luminance indication, implemented in this example as information stored in one or more DPCD registers (without excluding other possible implementations or values), appears in Table 7:

TABLE 7
EDGE_ZONE_PEAK_LUMINANCE
Stores the peak luminance of edge zones (e.g., in 24-bits).
Edge zones are zones that have no backlight zones surrounding one
of its adjacent sides. Value indicates luminance (e.g., is in units of
milli-nits). Valid when
ADVANCED_BACKLIGHT_ZONE_CONTROL_SUPPORT is set to
indicate that advanced backlight zone control is supported (e.g., 1 as
described with respect to Table 1. Otherwise, the value of this
register shall be “Don't Care.”

An example panel light spread function indication, in some implementations, indicates the luminance of a backlight zone based on a combination of its own output and the luminance level of neighboring backlight zones. In some implementations, a light spread function is expressed as an array of luminance values, where each index of the array represents its luminance contribution to its surrounding zones. To calculate the luminance of a particular zone is equal to the sum of contributions from neighboring zones.

A description of an example panel light spread function indication, implemented in this example as information stored in one or more DPCD registers (without excluding other possible implementations or values), appears in Table 8:

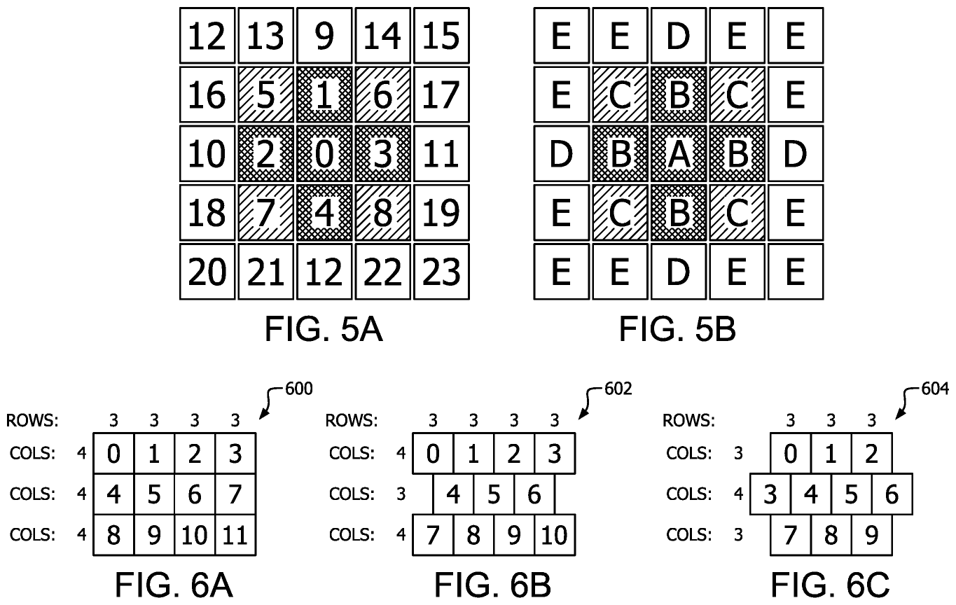

```
TABLE 8
PANEL_LIGHT_SPREAD_FUNCTION
  Defines an array of values, where each index of the array
represents its luminance contribution factor to its surrounding zones.
To calculate the real measured luminance on the glass of the panel,
the luminance of a particular zone is equal to the sum of its own
luminance output plus the contribution from neighboring zones.
  Luminance contribution factor follow the example illustrated
pattern shown and described with respect to FIGS. 5A and 5B, and
the luminance is calculated according to the example of equation 1.
```

FIG. 5A is a block diagram illustrating contribution of luminance of various zones of a backlight 500 to one another. In FIG. 5A, the center zone is labeled as zone 0, and numbered surrounding zones contribute luminance to zone 0.

FIG. 5B is a block diagram further illustrating the contribution of luminance values of the zones of backlight 500 to one another. In FIG. 5B, the value of the luminance contribution of each zone to the luminance of zone 0 is indicated by a variable. In some implementations, the contribution of each zone to the luminance of zone 0 is proportional to, or otherwise based on, its distance from zone 0.

Equation 1 expresses the contribution of each zone to the luminance of zone 0 using a panel light spread function:

$$Luminance [ Zone 0 ] = {A}^{*} ( Zone 0 ) + {B}^{*} ( Zone 1 + Zone 2 + … ) + {C}^{*} ( Zone 5 + Zone 6 + … ) + {D}^{*} ( Zone 9 + Zone 10 + … ) + {E}^{*} ( Zone 12 + Zone 13 + … ) \qquad Equation 1$$

A backlight zone columns indication, in some implementations, indicates the number of columns of backlight zones in the backlight array. Backlight zone rows, in some implementations, indicates the number of rows of backlight zones in the backlight array.

A description of an example backlight zone columns indication, implemented in this example as information stored in one or more DPCD registers (without excluding other possible implementations or values), appears in Table 9:

TABLE 9
BACKLIGHT_ZONE_COLUMNS
Defines the number of columns of backlight zones that can be
independently controlled. Valid when
ADVANCED_BACKLIGHT_ZONE_CONTROL_SUPPORT is set to
indicate that advanced backlight zone control is supported (e.g., 1 as
described with respect to Table 1. Otherwise, the value of this
register shall be “Don't Care.”

An example backlight zone rows indication, implemented in this example as information stored in one or more DPCD registers (without excluding other possible implementations or values), appears in Table 10:

TABLE 10
BACKLIGHT_ZONE_ROWS
Defines the number of rows of backlight zones that can be
independently controlled. Valid when
ADVANCED_BACKLIGHT_ZONE_CONTROL_SUPPORT is set to
indicate that advanced backlight zone control is supported (e.g., 1 as
described with respect to Table 1. Otherwise, the value of this
register shall be “Don't Care.”

A backlight zone arrangement indication, in some implementations, indicates how the backlight zones are arranged with respect to one another. In some implementations, the backlight zone arrangement indicates whether the backlight zones are uniform throughout the display, or exhibit some different arrangement patterns. For example, in some implementations, the backlight zone arrangement information indicates whether the backlight zones are uniform over the display, alternating with first row having more columns, alternating with first row having less columns, or any other suitable arrangement of backlight zones. In some implementations, uniform zone arrangement information indicates that backlight zones are arranged in rows and columns, where each row and column has the same number of zones as any other row and column, respectively.

In some implementations, alternating zone arrangement information indicates that the backlight zones are arranged in rows, where the first row has a first number (e.g., “LED zone columns”) of zones. The second row has one (or any suitable indicated number) fewer zone, and the zones are arranged so that, horizontally, the zone is placed in the center between two adjacent zones of row 1. Alternating rows repeat. For example, the third row has the same arrangement as row 1, and the fourth row has the same arrangement as row 2 in this example, etc.

In some implementations, alternating zone arrangement information indicates that the backlight zones are arranged in rows, where the first row has a first number (e.g., “LED zone columns”) of zones. The second row has one (or any suitable indicated number) fewer zone, and the zones are arranged so that, horizontally, the zone is placed in the center between two adjacent zones of the first row. Alternating rows repeat. For example, the third row has the same arrangement as the first row, and the fourth row has the same arrangement as the second row in this example, etc.

In some implementations, alternating zone arrangement information indicates that the backlight zones are arranged in rows, where the second row has a first number (e.g., “LED zone columns”) of zones. The first row has one (or any suitable indicated number) fewer zone, and the zones are arranged so that, horizontally, the zone is placed in the center between two adjacent zones of row 2. Alternating rows repeat. For example, the third row has the same arrangement as row 1, and the fourth row has the same arrangement as row 2 in this example, etc.

FIGS. 6A, 6B, and 6C are block diagrams which illustrate example backlight zone arrangements 600, 602, and 604, e.g., as described above, where backlight zones are uniform over the display, alternating with first row having more columns, and alternating with first row having fewer columns, respectively.

A description of an example backlight zone arrangement indication, implemented in this example as information stored in one or more DPCD registers (without excluding other possible implementations or values), appears in Table 11:

TABLE 11
BACKLIGHT_ZONE_ARRANGEMENT
Defines the physical arrangement of backlight zones with
offset values. Odd and even rows contain less zones as indicated
by the offset value. A row_offset(0,0) indicates a perfectly
rectangular backlight zone arrangement. A row_offset(1,0) indicates
odd rows contain one less backlight zone. A row_offset(0,2)
indicates even rows contain two less backlight zones. Valid when
ADVANCED_BACKLIGHT_ZONE_CONTROL_SUPPORT is set to
indicate that advanced backlight zone control is supported (e.g., 1 as
described with respect to Table 1.) Otherwise, the value of this
register shall be “Don't Care.”

A LED arrangement within a zone indication, in some implementations, indicates how LEDs are arranged within a backlight zone. For example, if a zone has 4 LEDs, they may be arranged in a square or rectangular pattern, etc.

A description of an example backlight zone arrangement indication, implemented in this example as information stored in one or more DPCD registers (without excluding other possible implementations or values), appears in Table 12:

TABLE 12
LED_WITHIN_A_ZONE_ARRANGEMENT
Defines the physical arrangement of LEDs within a zone. A
value indicates how many LEDs are in a zone. A value indicates an
arrangement of LEDs within the zone (e.g., square, rectangle). Valid
when ADVANCED_BACKLIGHT_ZONE_CONTROL_SUPPORT is
set to indicate that advanced backlight zone control is supported
(e.g., 1 as described with respect to Table 1.) Otherwise, the value
of this register shall be “Don't Care.”

A backlight luminance adjustment granularity indication, in some implementations, refers to a resolution of backlight luminance adjustment that is possible for each backlight zone. In some implementations, backlight luminance adjustment granularity indicates how finely the source is able to control the luminance output of each backlight zone. For example, in some implementations, a backlight luminance adjustment granularity of 0.01 nits indicates that the source device and/or the sink device can configure a backlight zone to output at 0.05 nits or 0.06 nits, but the backlight cannot (e.g., physically) be configured to output at a luminance between these levels (e.g., at 0.055 nits).

A description of an example backlight luminance adjustment indication, implemented in this example as information stored in one or more DPCD registers (without excluding other possible implementations or values), appears in Table 13:

TABLE 13
BACKLIGHT_ZONE_NITS_GRANULARITY
Defines the granularity of each backlight zone (e.g., in units of
milli-nits.) Example valid values range from 1 - 65535 milli-nits. A
value of 0 indicates the panel has no limitations on backlight
granularity. Valid when
ADVANCED_BACKLIGHT_ZONE_CONTROL_SUPPORT is set to
indicate that advanced backlight zone control is supported (e.g., 1 as
described with respect to Table 1.) Otherwise, the value of this
register shall be “Don't Care.”

In some implementations, the host or source device sends information to the display or sink device in order to facilitate regional backlight control. Any suitable information, such as control information, is sent to the display or sink device in some implementations. This information is sent in any suitable manner, and is stored on the display or sink device, or other device in communication with the display or sink device, in any suitable manner.

For example, in some implementations, the control information is transmitted over AUX via DPCD; via a Secondary Data Packet (SDP) (e.g., a chained SDP); in an InfoFrame, in an Extended Metadata Packet, and/or via data embedded in a pixel or other data stream.

In some implementations where the information transmitted to the display or sink device in order to facilitate regional backlight control is transmitted via a chained SDP info packet, the control information is transmitted in info packets which are transmitted in the same stream of data as the video data. Advantageously, this data is transmitted at a much higher faster rate and bandwidth than data transmitted over AUX via DPCD. Accordingly, it can transmit much larger amounts of data in a shorter amount of time. Further, because the chained SDP info packet is transmitted in-band with the video stream, the transmission is synchronous with the video frames in some implementations. Accordingly, in some implementations, when the source adjusts both the backlight zone and the corresponding pixel RGB content, the adjustment is sent synchronously.

In some implementations where the information transmitted to the display or sink device in order to facilitate regional backlight control is transmitted via data embedded in a pixel stream, the backlight zone adjustment information is embedded within the pixel stream itself; e.g., is encoded with the pixel data. In some implementations, transmitting backlight zone adjustment information in-band with the pixel stream has the advantage of facilitating per-zone backlight adjustments synchronous with the pixel data. In some implementations, this allows the source to adjust both the backlight zone and corresponding pixel RGB values synchronously.

In some implementations, the control information transmitted to the display or sink device in order to facilitate regional backlight control indicates one or more of: local dimming control information; global backlight luminance information; and/or backlight zone output luminance information.

Local dimming control information, in some implementations, configures the display or sink device for different modes of local backlight dimming operation. In some implementations, such modes of operation include at least one of the following modes: off, controlled by display (or sink) device, controlled by host (or source) device, and/or a hybrid control.

The off mode, in some implementations, configures the display or sink device not to use local dimming. In some implementations, the off mode configures the sink to maintain a uniform backlight output luminance across all zones.

The controlled by display (or sink) device mode, in some implementations, configures the display or sink device to determine whether to use local dimming. In some implementations, the display device is configured to use local dimming to reduce the backlight output luminance of individual backlight zones. In some implementations, the display or sink device is configured to adjust at least pixel RGB value in combination with a corresponding adjustment to backlight zone luminance, e.g., in order to produce an appearance of the corresponding pixel that matches an appearance of the corresponding pixel without adjustment to backlight zone luminance and pixel RGB value.

The controlled by host (or source) device mode, in some implementations, configures the display or sink device to allow the host or source device to control backlight zone luminances. In some implementations, the host device controls backlight zone luminances using control information (e.g., by writing the control information to the display device). In some implementations, the host device controls backlight zone luminances by transmitting backlight zone output luminance information, or as global backlight luminance information. In some implementations, the display or sink device is configured to not adjust pixel RGB values. In some implementations, the source optionally adjusts the pixel RGB values.

The hybrid control mode, in some implementations, configures the display or sink device to allow the host or source device to control local dimming of each backlight zone, and to configures the display or sink device with a target SDR peak white level, such that the display or sink device adjusts pixel RGB values to compensate for the local dimming of each backlight zone. In other words, the display or sink device is configured to adjust at least pixel RGB value in combination with a corresponding adjustment to backlight zone luminance, e.g., in order to produce an appearance of the corresponding pixel that matches an appearance of the corresponding pixel without adjustment to backlight zone luminance and pixel RGB value. In some implementations, the host or source device controls local dimming of the backlight, and the display or sink device controls adjustment of pixel RGB values to compensate for the local dimming of the backlight.

A description of an example local dimming control information indication, implemented in this example as information written to one or more DPCD registers (without excluding other possible implementations or values), appears in Table 14:

```
TABLE 14
BACKLIGHT_ZONE_CONTROL_MODE_SET
  The following control modes are available when
ADVANCED_BACKLIGHT_ZONE_CONTROL_SUPPORT is set to
indicate that advanced backlight zone control is supported (e.g., 1 as
described with respect to Table 1.) Otherwise, writes to the registers
indicting the following control modes will be ignored.
BACKLIGHT_ZONE_CONTROL_MODE
  00h = Advanced backlight zone control is disabled. (default)
  01h = TCON controlled backlight zones. TCON may reduce
total panel power dissipation by analyzing the video frame contents
both globally and/or in individual backlight zones, then automatically
adjust the backlight brightness of each zone and modify pixel RGB
values. Implementation is panel-specific and may differ across panel
models. Valid only when
TCON_CONTROLLED_BACKLIGHT_ZONE_CAPABLE is set to
indicate that TCON is capable of independently controlling the
backlight brightness of multiple backlight zones (e.g., 1 as described
with respect to Table 2.)
  02h = Source controlled backlight zones. Source controls the
luminance of each individual backlight zone. Sink shall not modify
pixel RGB values while this mode is active. The method of Source
transmission of backlight zone luminance values is dependent on the
setting of BACKLIGHT_ZONE_PASSTHROUGH_ENABLE, e.g., as
discussed below. Valid only when
SOURCE_CONTROLLED_BACKLIGHT_ZONE_CAPABLE is set to
indicate that Source is capable of explicitly controlling the backlight
brightness of multiple backlight zones. (e.g., 1 as described with
respect to Table 2.)
  03h = Hybrid controlled backlight zones. Source controls the
luminance of each individual backlight zone along with providing the
sink with a target SDR peak white level. Source shall indicate the
target SDR peak white level through
TARGET_SDR_PEAK_WHITE_SET (e.g. as described with respect
to Table 15). The method of Source transmission of backlight zone
luminance values is dependent on the setting of
BACKLIGHT_ZONE_PASSTHROUGH_ENABLE, e.g., as
discussed below. Sink device shall modify pixel RGB values in order
to compensate for backlight zones where its luminance value is set
lower than the target SDR peak white level. Valid only when
HYBRID_BACKLIGHT_ZONE_CAPABLE is set to indicate that ink
is capable of supporting a hybrid mode where both Source and
TCON are controlling the backlight brightness of multiple backlight
zones. (e.g., 1 as described with respect to Table 2.)
BACKLIGHT_ZONE_PASSTHROUGH_ENABLE
  0 = Source is transmitting a nits-based value to control
backlight zone luminance. 1 = Source is transmitting an internal
backlight control value that should be directly written to the panel's
internal backlight registers.
```

A description of an example target SDR peak white level indication, implemented in this example as information written to one or more DPCD registers (without excluding other possible implementations or values), appears in Table 15:

TABLE 15
TARGET_SDR_PEAK_WHITE_SET
Value is used when BACKLIGHT_ZONE_CONTROL_MODE
is set to indicate that Hybrid controlled backlight zones are
supported. Defines the target SDR peak white level. While SDR
video stream is transmitted, the maximum pixel code value shall
target the value reported in this field. When Source requests a
backlight zone luminance value lower than the
TARGET_SDR_PEAK_WHITE SET, Sink shall modify pixel RGB
values to compensate. Implementation is panel-specific and may
differ across panel models. Valid when
ADVANCED_BACKLIGHT_ZONE_CONTROL_SUPPORT is set to
indicate that advanced backlight zone control is supported (e.g., 1 as
described with respect to Table 1.) Otherwise, the value of this
register shall be “Don't Care.”

Global backlight luminance information, in some implementations, indicates a global luminance for a backlight of the display device. In some implementations, the global backlight luminance information is applied equally across all zones of the backlight if local dimming is disabled.

The global backlight luminance information is expressed in any suitable format. For example, in some implementations, a value of the global backlight luminance information is a value which has a valid range based on a value reported by the display device to the host device (e.g., a maximum average backlight luminance). For example, in some implementations, the value of the global backlight luminance information, ranges between 0 and a maximum average backlight luminance reported by the display device to the host device.

Backlight zone output luminance information, in some implementations, indicates a luminance for a single zone of a backlight of the display device. In some implementations, separate backlight zone output luminance information is provided for each backlight zone. In some implementations, the separate information is provided in separate fields, (e.g., for N zones, backlight zone [0] output luminance . . . backlight zone [N] output luminance), or in an array within a single field. In some implementations, the backlight zone output luminance information indicates a luminance value for a single zone of a backlight of the display device. In some implementations, the backlight zone output luminance indicates a luminance value for a group of zones of the backlight of the display device. In some implementations, the backlight zone output luminance indicates a value (e.g., in nits or Candela per square meter) which corresponds to, and is convertible by the sink device (e.g., by TCON or other hardware of a display) into a local value (e.g., a backlight drive strength value) to control luminance for a zone of the backlight of the display device. In some implementations, the backlight zone output luminance indicates a raw value (e.g., a backlight drive strength value) usable by the sink device (e.g., by TCON or other hardware of a display) to control luminance for a zone of the backlight of the display device, e.g., without conversion into a local value.

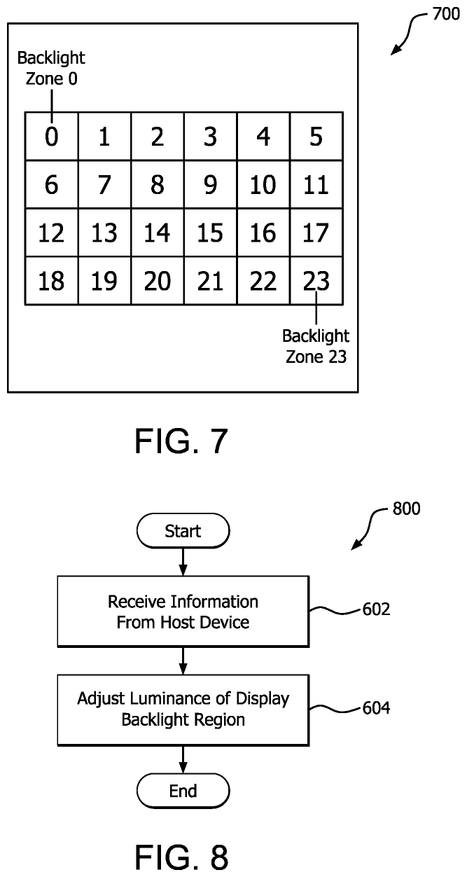

FIG. 7 is a block diagram illustrating an example backlight 700 of a display. Backlight 700 includes 24 regions, numbered in raster-like fashion from 0 to 23 as shown. In some implementations, backlight zone adjustment information is transmitted to the display or sink device in order to facilitate regional backlight control of regions 0 to 23.

In some implementations, a chained SDP is transmitted by the source to control each backlight zone. Table 16 describes an example chained SDP. In this example, each zone is given a 32-bit (4 byte) value representing either a luminance value in units of milli-nits, or an internal panel backlight value (e.g., depending on whether BACKLIGHT_ZONE PASSTHROUGH CONTROL CAPABLE, as described in TABLE 2 (or another indication), indicates that PASSTHROUGH mode is enabled.)

TABLE 16

| Header | | | | | | | | |
|---|---|---|---|---|---|---|---|---|
| Byte | 7 | 6 | 5 | 4 | 3 | 2 | 1 | 0 |
| HB0 | Packet ID = 0x00 | | | | | | | |
| HB1 | Secondary-data Packet Type = 0xXX (New Packet Type ID to be defined) | | | | | | | |
| HB2 | MIDDLE_OF_CHAINING = 1 | RESERVED (Read all 0s) | | | | | | |
| HB3 | RESERVED (Read all 0s) | | | PACKET_SEQUENCE_ID = 0 | | | | |
| Data | | | | | | | | |
| Byte | 7 | 6 | 5 | 4 | 3 | 2 | 1 | 0 |
| DB0 | Backlight Zone 0, Luminance Value Byte 0 | | | | | | | |
| DB1 | Backlight Zone 0, Luminance Value Byte 1 | | | | | | | |
| DB2 | Backlight Zone 0, Luminance Value Byte 2 | | | | | | | |
| DB3 | Backlight Zone 0, Luminance Value Byte 3 | | | | | | | |
| DB4 | Backlight Zone 1, Luminance Value Byte 0 | | | | | | | |
| DB5 | Backlight Zone 1, Luminance Value Byte 1 | | | | | | | |
| DB6 | Backlight Zone 1, Luminance Value Byte 2 | | | | | | | |
| DB7 | Backlight Zone 1, Luminance Value Byte 3 | | | | | | | |
| DB8 | Backlight Zone 2, Luminance Value Byte 0 | | | | | | | |
| DB9 | Backlight Zone 2, Luminance Value Byte 1 | | | | | | | |
| DB10 | Backlight Zone 2, Luminance Value Byte 2 | | | | | | | |
| DB11 | Backlight Zone 2, Luminance Value Byte 3 | | | | | | | |
| DB12 | Backlight Zone 3, Luminance Value Byte 0 | | | | | | | |
| DB13 | Backlight Zone 3, Luminance Value Byte 1 | | | | | | | |
| DB14 | Backlight Zone 3, Luminance Value Byte 2 | | | | | | | |
| DB15 | Backlight Zone 3, Luminance Value Byte 3 | | | | | | | |
| DB16 | Backlight Zone 4, Luminance Value Byte 0 | | | | | | | |
| DB17 | Backlight Zone 4, Luminance Value Byte 1 | | | | | | | |
| DB18 | Backlight Zone 4, Luminance Value Byte 2 | | | | | | | |
| DB19 | Backlight Zone 4, Luminance Value Byte 3 | | | | | | | |
| DB20 | Backlight Zone 5, Luminance Value Byte 0 | | | | | | | |
| DB21 | Backlight Zone 5, Luminance Value Byte 1 | | | | | | | |
| DB22 | Backlight Zone 5, Luminance Value Byte 2 | | | | | | | |
| DB23 | Backlight Zone 5, Luminance Value Byte 3 | | | | | | | |
| DB24 | Backlight Zone 6, Luminance Value Byte 0 | | | | | | | |
| DB25 | Backlight Zone 6, Luminance Value Byte 1 | | | | | | | |
| DB26 | Backlight Zone 6, Luminance Value Byte 2 | | | | | | | |
| DB27 | Backlight Zone 6, Luminance Value Byte 3 | | | | | | | |
| DB28 | Backlight Zone 7, Luminance Value Byte 0 | | | | | | | |
| DB29 | Backlight Zone 7, Luminance Value Byte 1 | | | | | | | |
| DB30 | Backlight Zone 7, Luminance Value Byte 2 | | | | | | | |
| DB31 | Backlight Zone 7, Luminance Value Byte 3 | | | | | | | |
| Header | | | | | | | | |
| Byte | 7 | 6 | 5 | 4 | 3 | 2 | 1 | 0 |
| HB0 | Packet ID = 0x00 | | | | | | | |
| HB1 | Secondary-data Packet Type = 0xXX (New Packet Type ID to be defined) | | | | | | | |
| HB2 | MIDDLE_OF_CHAINING = 1 | RESERVED (Read all 0s) | | | | | | |
| HB3 | RESERVED (Read all 0s) | | | PACKET_SEQUENCE_ID = 1 | | | | |
| Data | | | | | | | | |
| Byte | 7 | 6 | 5 | 4 | 3 | 2 | 1 | 0 |
| DB0 | Backlight Zone 8, Luminance Value Byte 0 | | | | | | | |
| DB1 | Backlight Zone 8, Luminance Value Byte 1 | | | | | | | |
| DB2 | Backlight Zone 8, Luminance Value Byte 2 | | | | | | | |
| DB3 | Backlight Zone 8, Luminance Value Byte 3 | | | | | | | |
| DB4 | Backlight Zone 9, Luminance Value Byte 0 | | | | | | | |
| DB5 | Backlight Zone 9, Luminance Value Byte 1 | | | | | | | |
| DB6 | Backlight Zone 9, Luminance Value Byte 2 | | | | | | | |
| DB7 | Backlight Zone 9, Luminance Value Byte 3 | | | | | | | |
| DB8 | Backlight Zone 10, Luminance Value Byte 0 | | | | | | | |
| DB9 | Backlight Zone 10, Luminance Value Byte 1 | | | | | | | |
| DB10 | Backlight Zone 10, Luminance Value Byte 2 | | | | | | | |
| DB11 | Backlight Zone 10, Luminance Value Byte 3 | | | | | | | |
| DB12 | Backlight Zone 11, Luminance Value Byte 0 | | | | | | | |
| DB13 | Backlight Zone 11, Luminance Value Byte 1 | | | | | | | |
| DB14 | Backlight Zone 11, Luminance Value Byte 2 | | | | | | | |
| DB15 | Backlight Zone 11, Luminance Value Byte 3 | | | | | | | |
| DB16 | Backlight Zone 12, Luminance Value Byte 0 | | | | | | | |
| DB17 | Backlight Zone 12, Luminance Value Byte 1 | | | | | | | |
| DB18 | Backlight Zone 12, Luminance Value Byte 2 | | | | | | | |
| DB19 | Backlight Zone 12, Luminance Value Byte 3 | | | | | | | |
| DB20 | Backlight Zone 13, Luminance Value Byte 0 | | | | | | | |
| DB21 | Backlight Zone 13, Luminance Value Byte 1 | | | | | | | |
| DB22 | Backlight Zone 13, Luminance Value Byte 2 | | | | | | | |
| DB23 | Backlight Zone 13, Luminance Value Byte 3 | | | | | | | |
| DB24 | Backlight Zone 14, Luminance Value Byte 0 | | | | | | | |
| DB25 | Backlight Zone 14, Luminance Value Byte 1 | | | | | | | |
| DB26 | Backlight Zone 14, Luminance Value Byte 2 | | | | | | | |
| DB27 | Backlight Zone 14, Luminance Value Byte 3 | | | | | | | |
| DB28 | Backlight Zone 15, Luminance Value Byte 0 | | | | | | | |
| DB29 | Backlight Zone 15, Luminance Value Byte 1 | | | | | | | |
| DB30 | Backlight Zone 15, Luminance Value Byte 2 | | | | | | | |
| DB31 | Backlight Zone 15, Luminance Value Byte 3 | | | | | | | |
| Header | | | | | | | | |
| Byte | 7 | 6 | 5 | 4 | 3 | 2 | 1 | 0 |
| HB0 | Packet ID = 0x00 | | | | | | | |
| HB1 | Secondary-data Packet Type = 0xXX (New Packet Type ID to be defined) | | | | | | | |
| HB2 | MIDDLE_OF_CHAINING = 0 | RESERVED (Read all 0s) | | | | | | |
| HB3 | RESERVED (Read all 0s) | | | PACKET_SEQUENCE_ID = 2 | | | | |
| Data | | | | | | | | |
| Byte | 7 | 6 | 5 | 4 | 3 | 2 | 1 | 0 |

| | |
|---|---|
| DB0 | Backlight Zone 16, Luminance Value Byte 0 |
| DB1 | Backlight Zone 16, Luminance Value Byte 1 |
| DB2 | Backlight Zone 16, Luminance Value Byte 2 |
| DB3 | Backlight Zone 16, Luminance Value Byte 3 |
| DB4 | Backlight Zone 17, Luminance Value Byte 0 |
| DB5 | Backlight Zone 17, Luminance Value Byte 1 |
| DB6 | Backlight Zone 17, Luminance Value Byte 2 |
| DB7 | Backlight Zone 17, Luminance Value Byte 3 |
| DB8 | Backlight Zone 18, Luminance Value Byte 0 |
| DB9 | Backlight Zone 18, Luminance Value Byte 1 |
| DB10 | Backlight Zone 18, Luminance Value Byte 2 |
| DB11 | Backlight Zone 18, Luminance Value Byte 3 |
| DB12 | Backlight Zone 19, Luminance Value Byte 0 |
| DB13 | Backlight Zone 19, Luminance Value Byte 1 |
| DB14 | Backlight Zone 19, Luminance Value Byte 2 |
| DB15 | Backlight Zone 19, Luminance Value Byte 3 |
| DB16 | Backlight Zone 20, Luminance Value Byte 0 |
| DB17 | Backlight Zone 20, Luminance Value Byte 1 |
| DB18 | Backlight Zone 20, Luminance Value Byte 2 |
| DB19 | Backlight Zone 20, Luminance Value Byte 3 |
| DB20 | Backlight Zone 21, Luminance Value Byte 0 |
| DB21 | Backlight Zone 21, Luminance Value Byte 1 |
| DB22 | Backlight Zone 21, Luminance Value Byte 2 |
| DB23 | Backlight Zone 21, Luminance Value Byte 3 |
| DB24 | Backlight Zone 22, Luminance Value Byte 0 |
| DB25 | Backlight Zone 22, Luminance Value Byte 1 |
| DB26 | Backlight Zone 22, Luminance Value Byte 2 |
| DB27 | Backlight Zone 22, Luminance Value Byte 3 |
| DB28 | Backlight Zone 23, Luminance Value Byte 0 |
| DB29 | Backlight Zone 23, Luminance Value Byte 1 |
| DB30 | Backlight Zone 23, Luminance Value Byte 2 |
| DB31 | Backlight Zone 23, Luminance Value Byte 3 |

In some implementations, alternatively, a chained SDP packet type can be used that allows repeat values to be avoided. In some implementations, a full packet sequence is transmitted with this methodology since the payload size is variable, depending on how many repeat values there are. In some implementations, e.g., where it is expected that backlight zones in proximity have similar luminance values, this transmission method may have the advantage of saving on the number of bytes during transmission.

For example, Table 17 describes an example chained SDP transmitted by the source to control each backlight zone, where the top and bottom rows are set to the same luminance value, whereas the middle backlight zones are set to a different luminance value. This may be advantageous, for example, in a scenario where a movie that is recorded in ultrawide aspect ratio, resulting in top and bottom borders that can be highly power optimized.

TABLE 17

| Header | | | | | | | | |
|---|---|---|---|---|---|---|---|---|
| Byte | 7 | 6 | 5 | 4 | 3 | 2 | 1 | 0 |
| HB0 | Packet ID = 0x00 | | | | | | | |
| HB1 | Secondary-data Packet Type = 0xXX (New Packet Type ID to be defined) | | | | | | | |
| HB2 | MIDDLE_OF_CHAINING = 0 | RESERVED (Read all 0s) | | | | | | |
| HB3 | RESERVED (Read all 0s) | | | PACKET_SEQUENCE_ID = 0 | | | | |
| Data | | | | | | | | |
| Byte | 7 | 6 | 5 | 4 | 3 | 2 | 1 | 0 |

| | |
|---|---|
| DB0 | Number of Zones = 6 |
| DB1 | Luminance Value Byte 0 = 100 Nits |
| DB2 | Luminance Value Byte 1 = 100 Nits |
| DB3 | Luminance Value Byte 2 = 100 Nits |
| DB4 | Luminance Value Byte 3 = 100 Nits |
| DB5 | Number of Zones = 12 |
| DB6 | Luminance Value Byte 0 = 200 Nits |
| DB7 | Luminance Value Byte 1 = 200 Nits |
| DB8 | Luminance Value Byte 2 = 200 Nits |
| DB9 | Luminance Value Byte 3 = 200 Nits |
| DB10 | Number of Zones = 6 |
| DB11 | Luminance Value Byte 0 = 100 Nits |
| DB12 | Luminance Value Byte 1 = 100 Nits |
| DB13 | Luminance Value Byte 2 = 100 Nits |
| DB14 | Luminance Value Byte 3 = 100 Nits |
| . . . | . . . |

In some implementations, supplemental backlight zone characteristics are stored in the persistent storage of a system (e.g., in system BIOS ROM or HDD/SDD of the device). In some implementations, these parameters are Read-Only parameters that are meant to override or supplement the values reported in the Backlight Zone Control DPCD Registers, and in some implementations, provide extended characteristics that may be too large in storage size to be kept in the DPCD ROM of the display.

A description of example supplemental backlight zone characteristics, implemented in this example as information written to one or more DPCD registers (without excluding other possible implementations or values), appears in Table 18:

```
TABLE 18
ER_ZONE_PEAK_LUMINANCE
  Stores the 24-bit peak luminance capable for a specific zone.
Each individual backlight zone may have different peak luminance
due to manufacturing, or due to non-uniform arrangement of
backlight zones.
  Values are stored contiguously in memory and arranged
starting with the top-left zone.
PANEL_LIGHT_SPREAD_FUNCTION
  Defines an array of values, where each index of the array
represents its luminance contribution factor to its surrounding zones.
To calculate the measured luminance on the glass of the panel, the
luminance of a particular zone is equal to the sum of its own
luminance output plus the contribution from neighboring zones.
  Value are, e.g., in units of 0.1%. (e.g., a value of 100
represents a 10% Contribution_Factor.)
LIGHT_SPREAD_FUNCTION_TYPE
  Describes how to interpret the data payload.
  xN - Indicates a unique Contribution_Factor for each zone
  xN*3 - Indicates a unique Contribution_Factor for each zone,
with the intensity of each component RGB having a different
Contribution_Factor
BACKLIGHT_ZONE_PASSTHROUGH_CHARACTERISITIC_FUNCTION
  Defines indexed points that map between Luminance (e.g., in
nits) and Internal_Panel_Backlight_Value. Source shall use these
points to calculate the required Internal_Panel_Backlight_Value
required to generate the desired luminance output of a specific
backlight zone. Luminance values are e.g., in milli-nits units.
Internal_Panel_Backlight_Values are e.g., in the panel's internal
format.
  Extended definition stored in system persistent storage may
be used to provide a more accurate correlation between luminance
and internal backlight value.
```

FIG. 8 is a flow chart illustrating an example procedure 800 for host- or source-controlled local backlight dimming. In 802, the display or sink device receives information from a host or source device. In 804, the display or sink device adjusts the luminance of at least one region of a backlight of the display based on the information.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, the SIMD units 138, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) operations and other intermediary data including netlists (such operations capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method for local dimming of a display backlight,
implemented in a display device, the method comprising:
transmitting display device capability information to a host device;
receiving information from the host device, wherein the information from the host device is based on the display device capability information and indicates local dimming control information; and
adjusting a luminance of at least one region of the display backlight, based on the information received from the host device.

2. The method of claim 1, wherein the information received from the host device indicates at least one of; global backlight luminance information; and/or backlight zone output luminance information.

3. (canceled)

4. The method of claim 1, wherein the display device capability information indicates at least one of: backlight zone control support, maximum average backlight luminance, peak zone luminance, peak center zone luminance, peak edge zone luminance, a panel light spread function, backlight zone columns, backlight zone rows, backlight zone arrangement, backlight arrangement within a zone, information mapping backlight drive strength to backlight luminance, and/or backlight nits granularity.

5. (canceled)

6. The method of claim 1, wherein the information received from the host device is received from the host device via at least one of AUX via Display Port Configuration Data (DPCD), chained Secondary Data Packet (SDP info) packet, data embedded in a pixel stream, and/or an embedded DisplayPort (eDP) interface.

7. The method of claim 1, wherein the information received from the host device is received synchronously with video frames.

8. The method of claim 1, further comprising converting the information received from the host device into a backlight drive strength value to control backlight luminance.

9. The method of claim 1, wherein the information received from the host device indicates a backlight drive strength to control backlight luminance.

10. The method of claim 1, wherein the display device capability information comprises a table mapping backlight drive strength to backlight luminance.

11. A device configured for local dimming of a display backlight, comprising:
transmitter circuitry configured to transmit display device capability information to a host device;
receiver circuitry configured to receive information from the host device, wherein the information from the host device is based on the display device capability information and indicates local dimming control information; and
processor circuitry configured to adjust a luminance of at least one region of the display backlight, based on the information received from the host device.

12. The device of claim 11, wherein the information received from the host device indicates at least one of; global backlight luminance information; and/or backlight zone output luminance information.

13. (canceled)

14. The device of claim 11, wherein the display device capability information indicates at least one of: backlight zone control support, maximum average backlight luminance, peak zone luminance, peak center zone luminance, peak edge zone luminance, a panel light spread function, backlight zone columns, backlight zone rows, backlight zone arrangement, backlight arrangement within a zone, information mapping backlight drive strength to backlight luminance, and/or backlight nits granularity.

15. (canceled)

16. The device of claim 11, wherein the information received from the host device is received from the host device via at least one of AUX via Display Port Configuration Data (DPCD), chained Secondary Data Packet (SDP info) packet, data embedded in a pixel stream, and/or an embedded DisplayPort (eDP) interface.

17. The device of claim 11, wherein the information received from the host device is received synchronously with video frames.

18. The device of claim 11, wherein the processor circuitry is further configured to convert the information received from the host device into a backlight drive strength value to control backlight luminance.

19. The device of claim 11, wherein the information received from the host device indicates a backlight drive strength to control backlight luminance.

20. The device of claim 11, wherein the display device capability information comprises a table mapping backlight drive strength to backlight luminance.
